(19) United States
(12) Patent Application Publication
(10) Pub. No.: US 2016/0114724 A1
(43) Pub. Date: Apr. 28, 2016

(54) COMBINED GRAB HANDLE AND LIGHT SOURCE ASSEMBLY

(71) Applicant: FORD GLOBAL TECHNOLOGIES, LLC, Dearborn, MI (US)

(72) Inventors: David Huelke, Milan, MI (US); Mike Popovski, Utica, MI (US); John Andrew Stakoe, Bloomfield Hills, MI (US); Jeff Todd Baxter, Carleton, MI (US)

(21) Appl. No.: 14/525,366

(22) Filed: Oct. 28, 2014

(51) Int. Cl. B60Q 3/02

(52) U.S. Cl. CPC B60Q 3/0233; B60Q 2500/10

(57) ABSTRACT

A combined grab handle and light source assembly includes an outer housing having a cavity and an open side. A grab handle and light source subassembly is rotatably mounted within that housing and is displaceable between a first position wherein a grab handle is provided on the open side and a light source assembly is hidden from view within the cavity and in a second position wherein the light source is provided on the open side and the grab handle is hidden from view within the cavity.

### TECHNICAL FIELD

This document relates generally to the vehicle equipment field and, more particularly, to a combined grab handle and light source assembly for the interior of a vehicle.

### BACKGROUND

The headliner of a motor vehicle typically incorporates a number of vehicle accessories including, for example, grab handles, coat hooks and interior lighting features. While grab handles are useful, they are also relatively unsightly when compared to what otherwise would be a smooth headliner surface.

This document relates to a new and improved combined grab handle and light source assembly incorporating a grab handle and light source subassembly that is rotatably mounted in a housing. When not in use, the grab handle is contained in a cavity in the housing out of sight and a smooth and aesthetically pleasing light source is oriented toward the passenger compartment of the vehicle.

### SUMMARY

In accordance with the purposes and benefits described herein, a combined grab handle and light source assembly is provided. That assembly comprises a door having a first face and a second face, a grab handle carried on the first face and a light source carried on the second face. The grab handle is oriented in a first direction and the light source is oriented in a second direction. In one possible embodiment the first face and the second face are opposite one another.

In one possible embodiment, the assembly further includes an outer housing. The door is received in that outer housing and pivotally mounted thereto. More specifically, the door includes a first end wall, a second end wall, a first pivot pin on the first end wall and a second opposed pivot pin on the second end wall. In one possible embodiment, the first end wall also includes a first electrical contact and the second end wall includes a second electrical contact. Together these contacts provide an electrical path for powering the light source when the light source is oriented in a direction to light the interior of the motor vehicle. In one possible embodiment, that light source includes a light emitting diode (LED) and a cooperating lens. In another possible embodiment the light source includes an incandescent bulb and a cooperating lens.

In accordance with an additional aspect, the combined grab handle and light source assembly may be described as comprising a housing, including a cavity and an open side, and a grab handle and light source subassembly. That grab handle and light source subassembly is rotatably mounted in the housing and displaceable between a first position wherein the grab handle is provided on the open side and a second position wherein the light source is provided on the open side.

In accordance with still another aspect, a method is provided of decluttering a headliner of the vehicle. That method may be described as comprising providing a grab handle and a light source on a door that is displaceable between a first position wherein the grab handle is exposed for use and the light source is hidden and a second position wherein the light source is exposed for use and the grab handle is hidden.

In the following description, there are shown and described several preferred embodiments of the combined grab handle and light source assembly. As it should be realized, the assembly is capable of other, different embodiments and its several details are capable of modification in various, obvious aspects all without departing from the assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the combined grab handle and light source assembly and together with the description serve to explain certain principles thereof. In the drawing:

FIG. 1 is an exploded perspective view of the combined grab handle and light source assembly illustrating the grab handle and light source subassembly, the housing in which the subassembly rotates and the u-shaped reinforcement bracket for mounting the assembly in the headliner of the vehicle.

FIG. 2a is a front elevational view of the assembly with the grab handle rotated to extend or project from the outer housing and the light source hidden from view in the cavity formed by the outer housing.

FIG. 2b is a side elevational view showing the combined grab handle and light source subassembly oriented as illustrated in FIG. 2a with the near sidewall removed to show a lamp assembly is hidden from view within the cavity of the outer housing.

FIG. 3a is a front elevational view of the assembly oriented so that the light source is exposed on the open side of the outer housing and the grab handle is held, hidden from view in the cavity formed by the outer housing.

FIG. 3b is a side elevational view of the assembly in the same orientation as illustrated in FIG. 3a with the nearside end wall removed to show how the grab handle is hidden from view in the cavity of the outer housing.

Reference will now be made in detail to the present preferred embodiment of the combined grab handle and light source assembly, examples of which are illustrated in the accompanying drawing figures.

### DETAILED DESCRIPTION

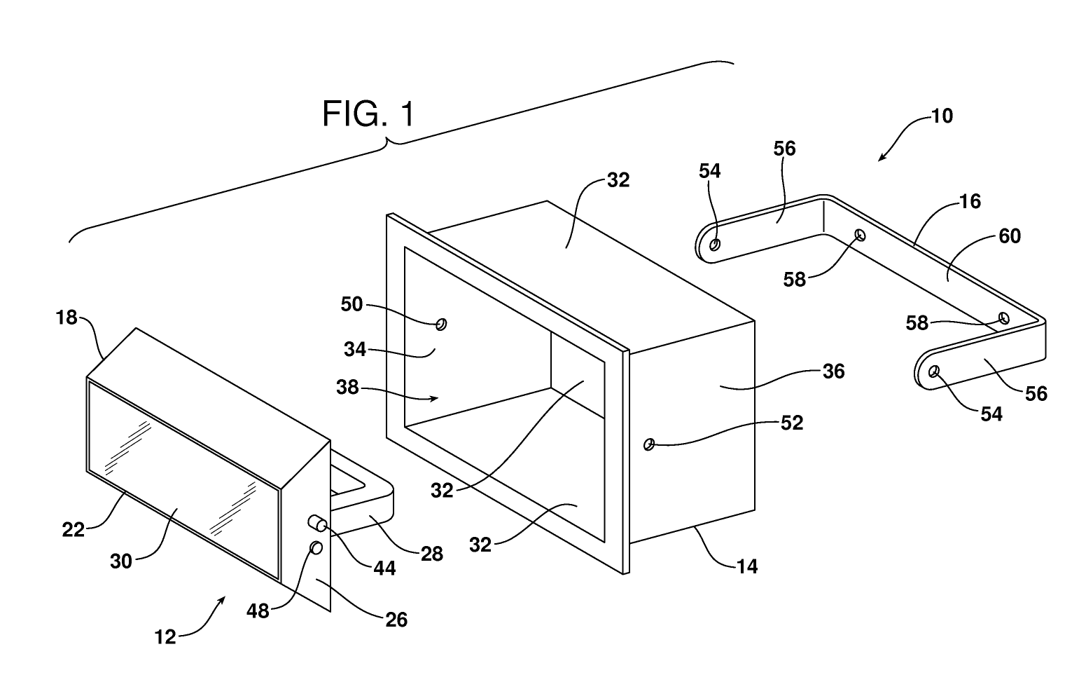

Reference is now made to FIGS. 1-3b illustrating the combined grab handle and light source assembly 10. As best illustrated in FIG. 1, the assembly 10 includes a grab handle and light source subassembly 12, an outer housing 14 and a reinforcement bracket 16. More specifically, the subassembly comprises a revolving door 18 including a first face 20 and a second face 22, a first end wall 24 and a second end wall 26. In the illustrated embodiment, the first and second faces 20, 22 are opposed. Further the first and second faces 20, 22 extend between the first and second end walls 24, 26.

A grab handle 28 is carried on the first face 20. A light source 30 is carried on the second face 22. Grab handle 28 may comprise a substantially C-shaped body made from plastic, metal, wood or other appropriate material. Light source 30 may include, for example, a light emitting diode (LED) and cooperating lens or an incandescent bulb and a cooperating lens.

As should be appreciated from the drawing figures, the grab handle 28 is oriented in a first direction and the light source 30 is oriented in a second direction.

The outer housing 14 has three sides 32, a first end 34 and a second end 36 that function to define a cavity 38. As should be appreciated the cavity 38 is open on one side.

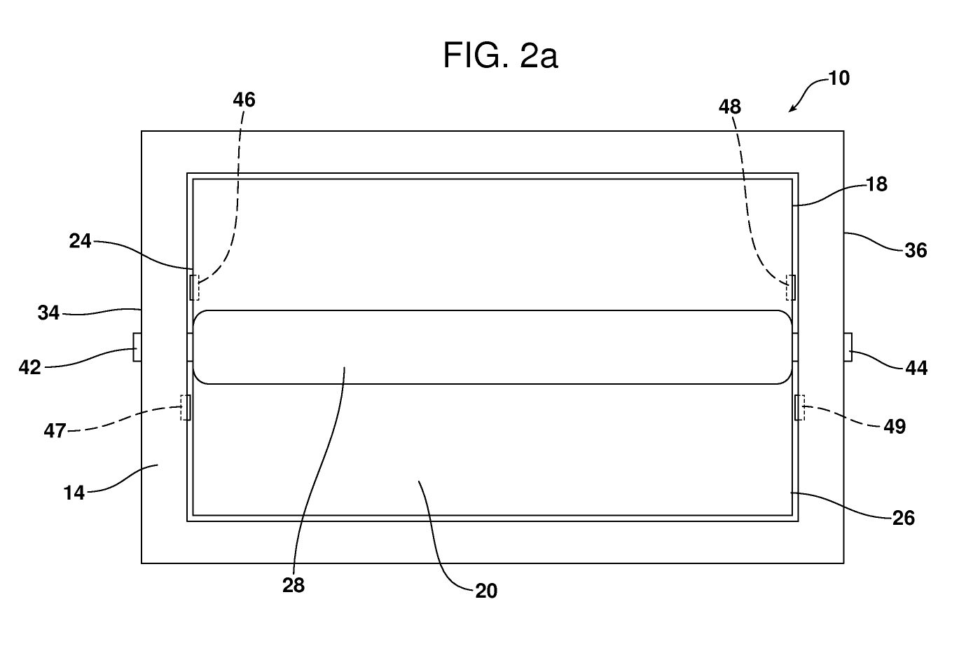

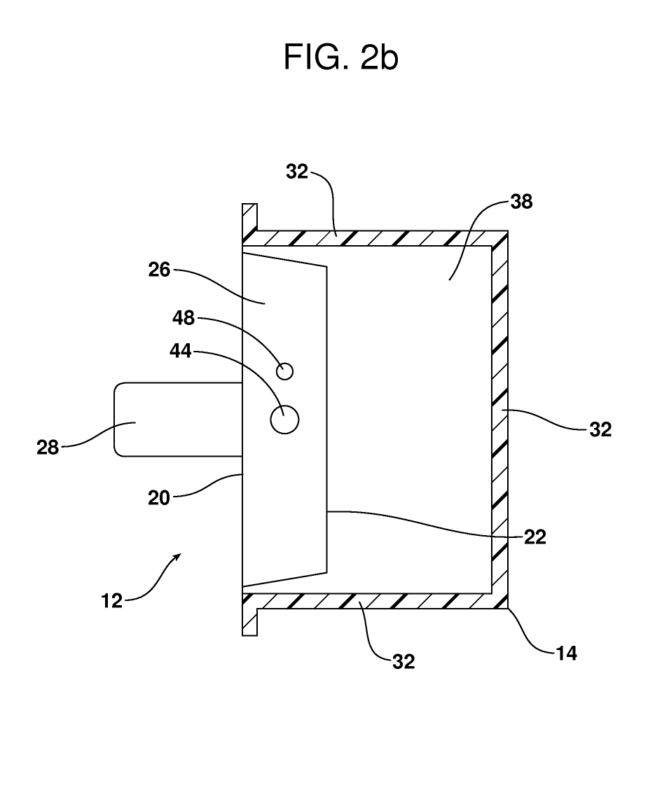

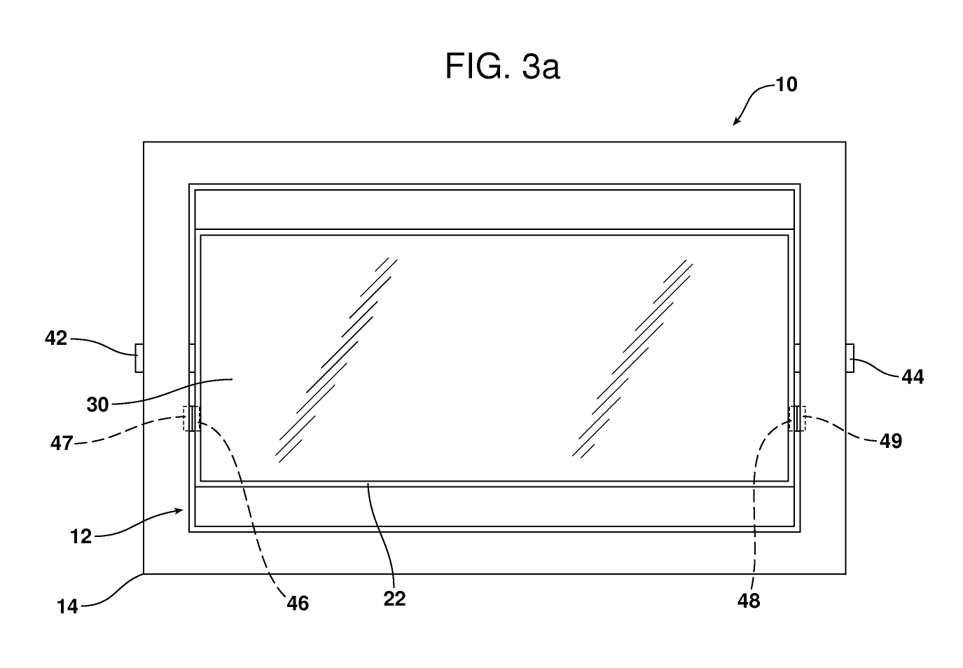

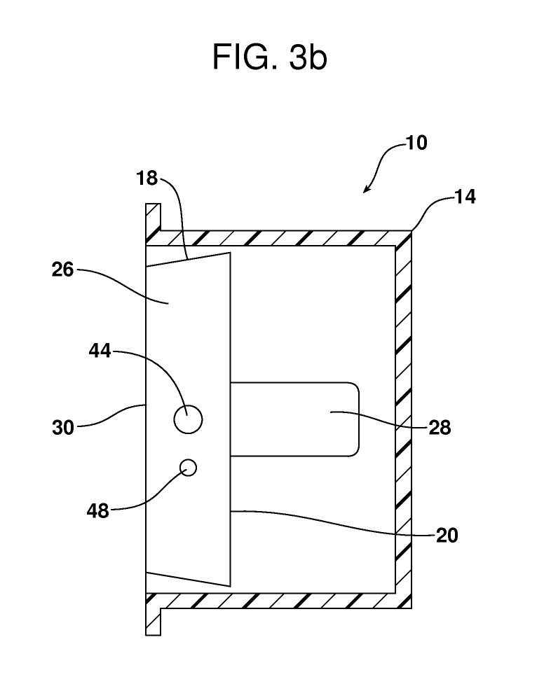

As should be appreciated, the subassembly 12 is rotatably mounted in the outer housing 14. More specifically, the subassembly 12 includes a first pivot pin 42 projecting from the first end wall 24 and a second, aligned pivot pin 44 projecting from the second end wall 26. In one possible embodiment, the first end wall 24 includes a first electrical contact 46 and the second end wall 26 includes a second electrical contact 48. These two contacts provide a pathway for providing electrical power to the light source 30 of the subassembly 12. More specifically, when the light source 30 is oriented as illustrated in FIGS. 3a and 3b to direct light into the interior of the motor vehicle, these contacts 46, 38 engage fixed contacts 47, 49 provided in the end walls 34, 36 of the outer housing creating an uninterrupted electrical pathway between the light source and a power supply (not shown). In contrast, when the light source 30 is oriented toward the cavity as illustrated in FIGS. 2a and 2b, the contacts 46, 48 are disengaged from the fixed contacts 47, 49 and that electrical pathway is interrupted. Thus, the light source 30 cannot be activated when hidden in the cavity 38 of the outer housing 14.

When assembled, the first pivot pin 42 and the second pivot pin 44 are received and held in respective sockets 50, 52 in the end walls 34, 36 of the outer housing 14. Significantly, the cavity 38 in the outer housing 14 is of sufficient dimension to allow the necessary clearance for the grab handle 28 to freely pass the sides 32 during rotation of the subassembly 12 relative to the outer housing 14. Thus, as illustrated in FIGS. 2a and 2b, the subassembly 12 may be oriented in the outer housing 14 so that the first face 20 and grab handle 28 are oriented outwardly from the housing 14 while the light source 30 is hidden from view within the cavity 38. In contrast, the subassembly 12 may also be oriented so that the second face 22 and light source 30 are oriented outwardly and the grab handle 28 is hidden from view within the cavity 38. Advantageously, this second position illustrated in FIGS. 3a and 3b 0provides an aesthetically pleasing smooth surface with the grab handle 28 hidden from view when it is not needed. A detent (not shown) may be provided to hold the subassembly 12 in either of the positions illustrated in FIGS. 2a, 2b and 3a, 3b.

The reinforcement bracket 16 functions to reinforce the outer housing 14 and provide a more secure connection to the body of the vehicle to which the assembly 10 is mounted. More specifically, the reinforcement bracket 16 is substantially u-shaped. As illustrated in FIG. 1, the reinforcement bracket 16 extends along the rearmost sidewall 32 and ends 34, 36 of the outer housing. Opposing apertures 54 in the two opposing end segments 56 of the bracket 16 receive and hold the ends of the pivot pins 42, 44. Apertures 58 in the center segment 60 of the bracket 16 receive screws or other fasteners utilized to secure the assembly 10 to the body of the vehicle.

In summary, the grab handle and light source assembly 10 provides a number of benefits. Most significantly, it functions to declutter the headliner and enhance the appearance thereof. When not in use, the grab handles 28 may simply be hidden from view behind the smooth, clean lines of the light source 30.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A combined grab handle and light source assembly, comprising:
a door having a first face and a second face;
a grab handle carried on said first face; and
a light source carried on said second face.

2. The assembly of claim 1, wherein said grab handle is oriented in a first direction and said light source is oriented in a second direction.

3. The assembly of claim 1, wherein said first face is opposite said second face.

4. The assembly of claim 1, further including an outer housing, said door being received in said outer housing.

5. The assembly of claim 4, wherein said door is pivotally mounted in said outer housing.

6. The assembly of claim 5, wherein said door includes a first end wall, a second end wall, a first pivot pin on said first end wall and a second opposed pivot pin on said second end wall.

7. The assembly of claim 6, wherein said first face and said second face extend between said first and second end walls.

8. The assembly of claim 7, wherein said first end wall includes a first electrical contact and said second end wall includes a second electrical contact.

9. The assembly of claim 8, wherein said light source includes an LED and a cooperating lens.

10. The assembly of claim 8, wherein said light source includes an incandescent bulb and a cooperating lens.

11. The assembly of claim 4, further including a reinforcement bracket secured to said outer housing.

12. The assembly of claim 11 wherein said reinforcement bracket is u-shaped.

13. A combined grab handle and light source assembly, comprising:
an outer housing including a cavity and an open side;
a grab handle and light source subassembly rotatably mounted in said housing and displaceable between a first position wherein a grab handle is provided on said open side and a second position wherein a light source is provided on said open side.

14. The assembly of claim 1, further including a reinforcement bracket secured to said outer housing.

15. The assembly of claim 14, wherein said reinforcement bracket is u-shaped.

16. The assembly of claim 13, wherein said subassembly includes a revolving door having a first end and a second end.

17. The assembly of claim 16, further including a first pivot pin on said first end and a second pivot pin on said second end.

18. The assembly of claim 17, further including a first electrical contact on said first end and a second electrical contact on said second end.

19. A method of decluttering a headliner of a vehicle, comprising:
providing a grab handle and a light source on a door that is displaceable between a first position wherein said grab handle is exposed for use and said light source is hidden and a second position wherein said light source is exposed for use and said grab handle is hidden.
